(19) United States
(12) Patent Application Publication
(10) Pub. No.: US 2007/0074000 A1
(43) Pub. Date: Mar. 29, 2007

(54) VLIW Acceleration System Using Multi-state Logic

(75) Inventors: Paul Colwill, Morgan Hill, CA (US); Henry T. Verheyen, San Jose, CA (US)

Correspondence Address: FENWICK & WEST LLP, SILICON VALLEY CENTER, 801 CALIFORNIA STREET, MOUNTAIN VIEW, CA, 94041, US

(73) Assignee: Liga Systems, Inc., Sunnyvale, CA (US)

(21) Appl. No.: 11/552,141

(22) Filed: Oct. 23, 2006

Related U.S. Application Data
(63) Continuation-in-part of application No. 11/238,505, filed on Sep. 28, 2005.
(60) Provisional application No. 60/732,078, filed on Oct. 31, 2005.

(51) Int. Cl. G06F 15/00

(52) U.S. Cl. 712/11

(57) ABSTRACT

A logic simulation processor uses multi-state logic (e.g., in 4-state, signals may take the values 0, 1, X or Z in the simulation of a semiconductor chip design). Typically a reduced number of basic multi-state logic functions are selected for the instruction set of the processor. Logic functions that are not part of the basic set are simulated by constructing them from combinations of the basic logic functions. In this way, the instruction length remains a manageable size but all logic functions that may occur can be simulated. The basic VLIW architecture can be extended to other applications.

### CROSS-REFERENCE TO RELATED APPLICATIONS

This application is a continuation-in-part of pending U.S. patent application Ser. No. 11/238,505, “Hardware Acceleration System for Logic Simulation Using Shift Register as Local Cache,” filed Sep. 28, 2005 by Watt and Verheyen; and claims priority under 35 U.S.C. § 119(e) to U.S. Provisional Patent Application Ser. No. 60/732,078, “VLIW Acceleration System Using Multi-state Logic,” filed Oct. 31, 2005 by Colwill and Verheyen. The subject matter of the foregoing are incorporated herein by reference in their entirety.

### BACKGROUND OF THE INVENTION

1. Field of the Invention

The present invention relates generally to VLIW (Very Long Instruction Word) processors, including for example simulation processors that may be used in hardware acceleration systems for logic simulation. More specifically, the present invention relates to the use of VLIW processors that implement multi-state logic.

2. Description of the Related Art

Simulation of a logic design typically requires high processing speed and a large number of operations due to the large number of gates and operations and the high speed of operation typically present in the logic design for modern semiconductor chips. One approach for logic simulation is software-based logic simulation (i.e., software simulators) where the logic is simulated by computer software executing on general purpose hardware. Unfortunately, software simulators typically are very slow. Another approach for logic simulation is hardware-based logic simulation (i.e., hardware emulators) where the logic of the semiconductor chip is mapped on a dedicated basis to hardware circuits in the emulator, and the hardware circuits then perform the simulation. Unfortunately, hardware emulators typically require high cost because the number of hardware circuits in the emulator increases in proportion to the size of the simulated logic design.

Still another approach for logic simulation is hardware-accelerated simulation. Hardware-accelerated simulation typically utilizes a specialized hardware simulation system that includes processor elements configurable to emulate or simulate the logic design. A compiler is typically provided to convert the logic design (e.g., in the form of a netlist or RTL (Register Transfer Language)) to a program containing instructions which are loaded to the processor elements to simulate the logic design. Hardware-accelerated simulation does not have to scale proportionally to the size of the logic design, because various techniques may be utilized to break up the logic design into smaller portions and then load these portions of the logic design to the simulation processor. As a result, hardware-accelerated simulators typically are significantly less expensive than hardware emulators. In addition, hardware-accelerated simulators typically are faster than software simulators due to the hardware acceleration produced by the simulation processor.

However, hardware-accelerated simulators generally require that instructions be loaded onto the simulation processor for execution and the data path for loading these instructions can be a performance bottleneck. Since the processor elements are configurable to simulate different logic functions, certain fields within the instruction are typically used to identify which logic function is to be simulated. For example, if the processor elements simulate logic functions with two input signals and one output signal (i.e., a dyadic function) and each signal can take one of two possible values (i.e., they are 2-state variables), then the logic function can be described by a truth table that has 2×2=4 entries, each of which can take 2 different values. There are 2ˆ4=16 possible truth tables or logic functions and a 4-bit field in the instruction would be sufficient to select from among all 16 possible logic functions.

Many simulations would benefit from multi-state logic, in which the variables can take more than two possible values. In logic simulation, 2-state simulations typically use 0 (logic low) and 1 (logic high) as the states. 4-state simulations are often desirable and would typically add states X (uninitialized or conflict) and Z (not driven). The X state represents logic states for which the condition is a conflict (e.g. driven simultaneously high and low), uninitialized, unknown (e.g. not driven) or intermediate (changing). Importantly, the X state addition enables the 0 and 1 states to be interpreted as a non-conflicted logic low and logic high states. The Z state models multi-source networks (e.g. buses), in which non-driving cells assume a high impedance (not driven) state and do not contribute to any conflict. In logic simulation, an X state on the input of a logic function may therefore produce an X state on the output of the logic function. For proper functioning of a design, no X state values should be present once logic simulation is completed, thus establishing that no problem of drive conflict or non-initialization of signals occurred. This is one reason why 4-state simulation is preferred over 2-state simulation.

In one approach to implementing 4-state simulation, the 4-state evaluation is broken down into two separate 2-state evaluations. Typically, six dyadic 2-state evaluations (of one output each) are required to produce the desired result. This approach comes at a cost of up to six times the resources and up to a six times decrease in performance and is therefore not very attractive.

In VLIW architectures, when moving from 2-state to 4-state computation, the four states can be modeled using two bits for each state (e.g., the states 0, 1, X, Z might be represented as 00, 01, 10, 11). Therefore, each logic function moves from a 2-input, 1-output definition to a 4-input, 2-output logic function. The associated truth table moves from a 2×2 table with 4 entries to two 4×4 tables with 16 entries each. The total number of possible truth tables increases from 2ˆ4=16 to 4ˆ16=2ˆ32 or approximately 4 billion. For a single processor element, producing two bit outputs, the relevant portion of the instruction increases from 4 bits to 32 bits. This is an addition of 28 bits to the instruction for a single processor element, or 28n bits if the simulation processor contains n processor elements. An increase in instruction length of this magnitude typically cannot be supported by current technology. Alternately, for a single processor element producing only a single bit output, two processor elements must be used, each using a 16 bit instruction. The instruction width increases from 4 bits to 16 bits (as opposed to 32 bits) but twice as many processor elements are needed. Equivalently, for a fixed number of processor elements, the overall processor capacity is reduced by a factor of two. Again, as the two processors work together, the relevant portion of the instruction increases from 1×4bits (2 state needs only one processing element) to 2×6bits (4-state needs two processing elements in this approach)=32 bits.

Therefore, there is a need for VLIW processors that can support multi-state logic (i.e., more than two states) without excessively increasing the instruction length.

### SUMMARY OF THE INVENTION

The present invention overcomes the limitations of the prior art by selecting a reduced number of basic multi-state logic functions for the instruction set. Logic functions that are not part of the basic set are simulated by constructing them from combinations of the basic logic functions. As a result, the instruction length remains a manageable size but all logic functions that may occur can be simulated. In one aspect, a simulation processor for performing logic simulation of a logic design includes a plurality of processor units that communicate via an interconnect system (e.g., a non-blocking crossbar in one design). Each of the processor units includes a processor element that is configurable to simulate a multi-state logic function.

In logic simulation of chip designs, 4-state simulation (0, 1, X, Z) is often desirable. In one approach, the 4-state logic function to be simulated is determined by an instruction received by the processor unit (or by a specific field within the instruction). A 32-bit field would be needed to encode all possible 4-state logic functions but, in various embodiments, 5-bit or 6-bit fields are used instead and the resulting instruction set is sufficient to simulate all logic functions that may be encountered during simulation, either directly or by combination of basic logic functions.

A 5-bit field would support 32 basic logic functions, which typically is less than the total number of distinct logic functions that may be encountered. The judicious selection of the basic logic functions will depend on the application. In many cases, the basic set will include at least one version of the NOT (bit-wise inversion) operator and/or at least all eight bubbled variants (i.e., all combinations of inverted and non-inverted inputs and outputs) of at least one operator (e.g., the Boolean AND operator).

In another aspect, assume that the basic set of logic functions include J multi-state logic functions. In one design, the processor element includes circuitry that generates output signals for all J basic logic functions. For example, the circuitry may include J lookup tables, one for each basic logic function. A multiplexer selects the appropriate output signal, depending on which logic function is specified in the instruction received by the processor unit.

Another aspect of the invention includes VLIW processors that implement multi-state logic but for purposes other than logic simulation of semiconductor chips. For example, integer arithmetic can be implemented as multi-state logic. If the operands are 4 bits wide, then they are 2ˆ4=16-state variables. The basic set for an arithmetic accelerator might include +, −, *, / and various other arithmetic functions that operate on 16-state variables. The output may or may not be the same width as the input operands. For example, the multiplication of two 4-bit operands may produce an 8-bit output. Applications that have inherent parallelism are good candidates for this processor architecture.

Other aspects of the invention include systems corresponding to the devices described above, applications for these devices and systems, and methods corresponding to all of the foregoing.

### BRIEF DESCRIPTION OF THE DRAWINGS

The teachings of the present invention can be readily understood by considering the following detailed description in conjunction with the accompanying drawings. Like reference numerals are used for like elements in the accompanying drawings.

FIG. 1 is a block diagram illustrating a hardware-accelerated logic simulation system according to one embodiment of the present invention.

FIG. 2 is a block diagram illustrating a simulation processor in the hardware-accelerated logic simulation system according to one embodiment of the present invention.

FIG. 3 is a circuit diagram illustrating a single processor unit of the simulation processor according to a first embodiment of the present invention.

FIG. 4 shows truth tables of bubbled variants of a 4-state dyadic AND.

FIG. 5A is a block diagram illustrating a processor element according to a first embodiment of the present invention.

FIG. 5B is a block diagram illustrating a processor element according to another embodiment of the present invention.

FIG. 6 is a block diagram of a 4-state processor unit.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF EMBODIMENTS

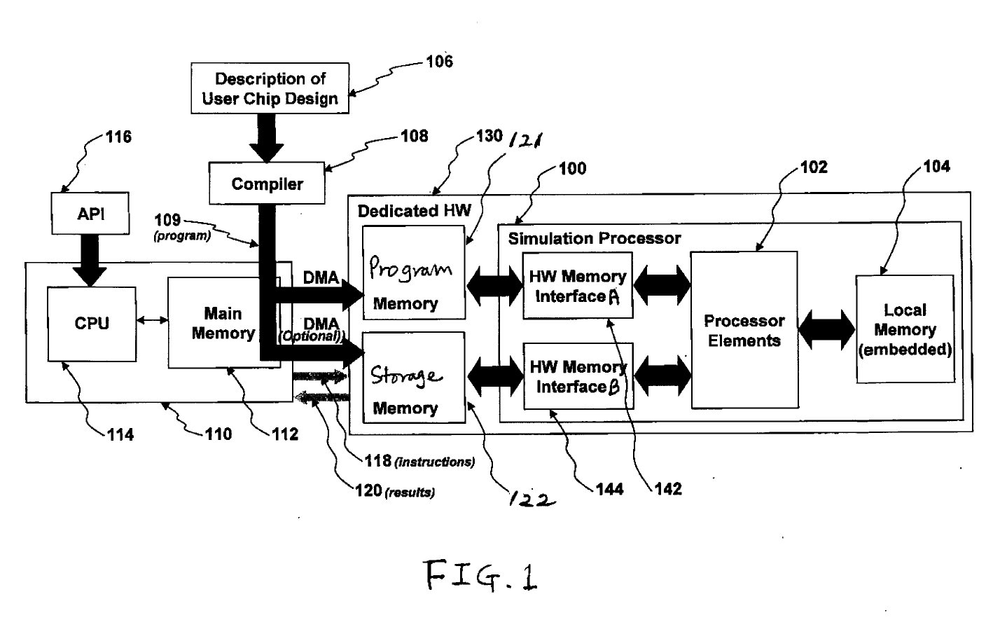

FIG. 1 is a block diagram illustrating a hardware accelerated logic simulation system according to one embodiment of the present invention. The logic simulation system includes a dedicated hardware (HW) simulator 130, a compiler 108, and an API (Application Programming Interface) 116. The computer 110 includes a CPU 114 and a main memory 112. The API 116 is a software interface by which the host computer 110 controls the simulation processor 100. The dedicated HW simulator 130 includes a program memory 121, a storage memory 122, and a simulation processor 100 that includes processor elements 102, an embedded local memory 104, a hardware (HW) memory interface A 142, and a hardware (HW) memory interface B 144.

The system shown in FIG. 1 operates as follows. The compiler 108 receives a description 106 of a user chip or logic design, for example, an RTL (Register Transfer Language) description or a netlist description of the logic design. The description 106 typically represents the logic design as a directed graph, where nodes of the graph correspond to hardware blocks in the design. The compiler 108 compiles the description 106 of the logic design into a program 109, which maps the logic design 106 against the processor elements 102 to simulate the logic design 106. The program 109 may also include the test environment (testbench) to simulate the logic design 106 in addition to representing the chip design 106 itself. For further descriptions of example compilers 108, see United States Patent Application Publication No. US 2003/0105617 A1, “Hardware Acceleration System for Logic Simulation,” published on Jun. 5, 2003, which is incorporated herein by reference. See especially paragraphs 191-252 and the corresponding figures. The instructions in program 109 are stored in main memory 112.

The simulation processor 100 includes a plurality of processor elements 102 for simulating the logic gates of the logic design 106 and a local memory 104 for storing instructions and data for the processor elements 102. In one embodiment, the HW simulator 130 is implemented on a generic PCI-board using an FPGA (Field-Programmable Gate Array) with PCI (Peripheral Component Interconnect) and DMA (Direct Memory Access) controllers, so that the HW simulator 130 naturally plugs into any general computing system 110. The simulation processor 100 forms a portion of the HW simulator 130. Thus, the simulation processor 100 has direct access to the main memory 112 of the host computer 110, with its operation being controlled by the host computer 110 via the API 116. The host computer 110 can direct DMA transfers between the main memory 112 and the memories 121, 122 on the HW simulator 130, although the DMA between the main memory 112 and the memory 122 may be optional.

The host computer 110 takes simulation vectors (not shown) specified by the user and the program 109 generated by the compiler 108 as inputs, and generates board-level instructions 118 for the simulation processor 100. The simulation vector (not shown) includes values of the inputs to the netlist 106 that is simulated. The board-level instructions 118 are transferred by DMA from the main memory 112 to the memory 121 of the HW simulator 130. The memory 121 also stores results 120 of the simulation for transfer to the main memory 112. The memory 122 stores user memory data, and can alternatively (optionally) store the simulation vectors (not shown) or the results 120. The memory interfaces 142, 144 provide interfaces for the processor elements 102 to access the memories 121, 122, respectively. The processor elements 102 execute the instructions 118 and, at some point, return simulation results 120 to the computer 110 also by DMA. Intermediate results may remain on-board for use by subsequent instructions. Executing all instructions 118 simulates the entire netlist 106 for one simulation vector. A more detailed discussion of the operation of a hardware-accelerated simulation system such as that shown in FIG. 1 can be found in United States Patent Application Publication No. US 2003/0105617 A1 published on Jun. 5, 2003, which is incorporated herein by reference in its entirety.

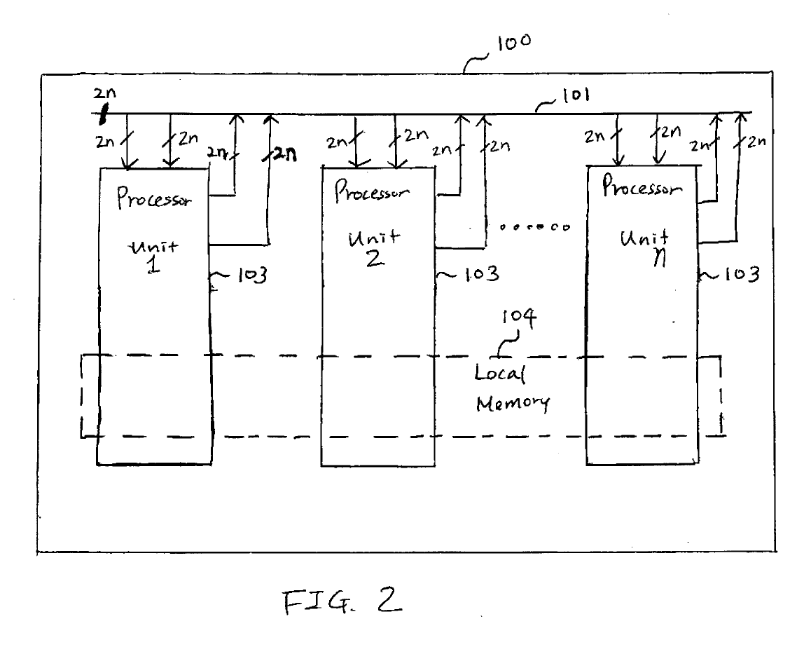

FIG. 2 is a block diagram illustrating the simulation processor 100 in the hardware-accelerated simulation system according to one embodiment of the present invention. The simulation processor 100 includes n processor units 103 (Processor Unit 1, Processor Unit 2, . . . Processor Unit n) that communicate with each other through an interconnect system 101. In this example, the interconnect system is a non-blocking crossbar. Each processor unit can take up to two inputs from the crossbar (denoted by the inbound arrows with slash and notation “2n”) and can generate up to two outputs for the crossbar (denoted by the outbound arrows with slash and notation “2n”). Thus, the crossbar is a 2n×2n crossbar that allows each input of each processor unit 103 to be coupled to any output of any processor unit 103. In this way, an intermediate value calculated by one processor unit can be made available for use as an input for calculation by any other processor unit.

For a simulation processor 100 containing n processor units, each having 2 inputs, 2n signals must be selectable in the crossbar for a non-blocking architecture. If each processor unit is identical, each preferably will supply two variables into the crossbar. This yields a 2n×2n non-blocking crossbar. However, this architecture is not required. Blocking architectures, non-homogenous architectures, optimized architectures (for specific design styles), shared architectures (in which processor units either share the address bits, or share either the input or the output lines into the crossbar) are some examples where an interconnect system 101 other than a non-blocking 2n×2n crossbar may be preferred.

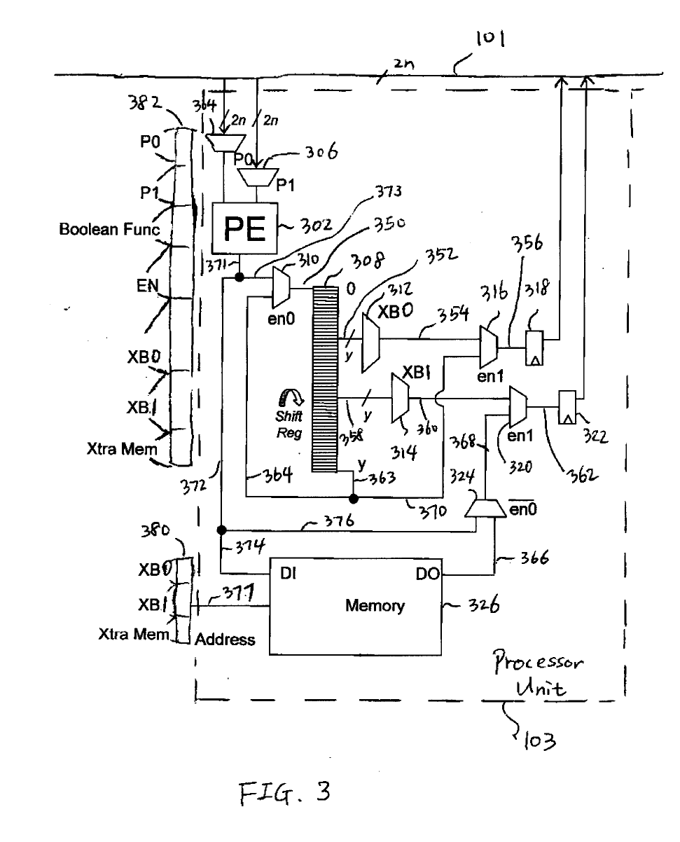

As will be shown in more detail with reference to FIG. 3, each of the processor units 103 includes a processor element (PE), a shift register, and a corresponding part of the local memory 104 as its memory. Therefore, each processor unit 103 can be configured to simulate at least one logic gate of the logic design 106 and store intermediate or final simulation values during the simulation.

FIG. 3 is a circuit diagram illustrating a single processor unit 103 of the simulation processor 100 in the hardware accelerated logic simulation system according to a first embodiment of the present invention. Each processor unit 103 includes a processor element (PE) 302, a shift register 308, an optional memory 326, multiplexers 304, 306, 310, 312, 314, 316, 320, 324, and flip flops 318, 322. The processor unit 103 is controlled by instructions 118 (shown as 382 in FIG. 3). The instruction 382 has fields P0, P1, Boolean Func, EN, XB0, XB1, and Xtra Mem in this example. Let each field X have a length of X bits. The instruction length is then the sum of P0, P1, Boolean Func, EN, XB0, XB1, and Xtra Mem in this example. A crossbar 101 interconnects the processor units 103.

The crossbar 101 has 2n bus lines, if the number of PEs 302 or processor units 103 in the simulation processor 100 is n and each processor unit has two inputs and two outputs to the crossbar. In a 2-state implementation, n represents n signals that are binary (either 0 or 1). In a 4-state implementation, n represents n signals that are 4-state coded (0, 1, X or Z) or dual-bit coded (e.g., 00, 01, 10, 11). In this case, we also refer to the n as n signals, even though there are actually 2n electrical (binary) signals that are being connected. Similarly, in a three-bit encoding (8-state), there would be n signals, each of which could take 8 different states, or a total of 3n electrical signals, and so forth.

The PE 302 is a configurable ALU (Arithmetic Logic Unit) that can be configured to simulate any logic gate with two or fewer inputs (e.g., NOT, AND, NAND, OR, NOR, XOR, constant 1, constant 0, etc.). The type of logic gate that the PE 302 simulates depends upon Boolean Func, which programs the PE 302 to simulate a particular type of logic gate. This can be extended to Boolean operations of three or more inputs by using a PE with more than two inputs.

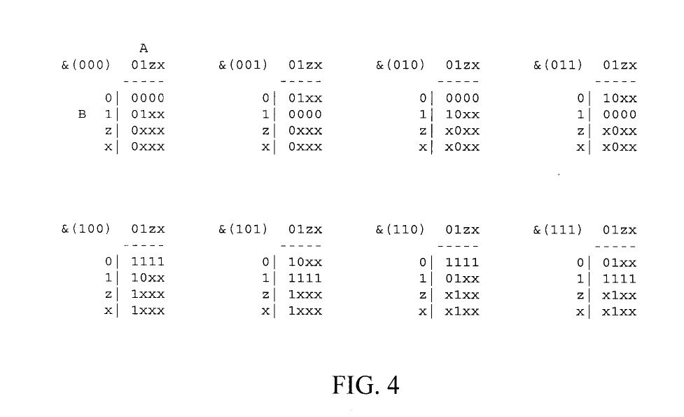

The number of bits in Boolean Func is determined in part by the number of different types of unique logic gates that the PE 302 is to simulate. For example, if each of the inputs is 2-state logic (i.e., a single bit, either 0 or 1) and the output is also 2-state, then the corresponding truth table is a 2×2 truth table (2 possible values for each input), yielding 2×2=4 possible entries in the truth table. Each entry in the truth table can take one of two possible values (2 possible values for each output). Thus, there are a total of 2ˆ4=16 possible truth tables that can be implemented. If every truth table is implemented, the truth tables are all unique, and Boolean Func is coded in a straightforward manner, then Boolean Func would require 4 bits to specify which truth table (i.e., which logic function) is being implemented. Correspondingly, the number Boolean Func would equal 4 bits in this example. Note that it is also possible to have Boolean Func of only 5 bits for 4-state logic with modifications to the circuitry, as will be described in greater detail in FIGS. 4-6.

The multiplexer 304 selects input data from one of the 2n bus lines of the crossbar 101 in response to a selection signal P0 that has P0 bits, and the multiplexer 306 selects input data from one of the 2n bus lines of the crossbar 101 in response to a selection signal P1 that has P1 bits. The PE 302 receives the input data selected by the multiplexers 304, 306 as operands, and performs the simulation according to the configured logic function as indicated by the Boolean Func signal. In the example of FIG. 3, each of the multiplexers 304, 306 for every processor unit 103 can select any of the 2n bus lines. The crossbar 101 is fully non-blocking and exhaustively connective, although this is not required.

The shift register 308 has a depth of y (has y memory cells), and stores intermediate values generated while the PEs 302 in the simulation processor 100 simulate a large number of gates of the logic design 106 in multiple cycles.

In the embodiment shown in FIG. 3, a multiplexer 310 selects either the output 371-373 of the PE 302 or the last entry 363-364 of the shift register 308 in response to bit en0 of the signal EN, and the first entry of the shift register 308 receives the output 350 of the multiplexer 308. Selection of output 371 allows the output of the PE 302 to be transferred to the shift register 308. Selection of last entry 363 allows the last entry 363 of the shift register 308 to be recirculated to the top of the shift register 308, rather than dropping off the end of the shift register 308 and being lost. In this way, the shift register 308 is refreshed. The multiplexer 310 is optional and the shift register 308 can receive input data directly from the PE 302 in other embodiments.

On the output side of the shift register 308, the multiplexer 312 selects one of they memory cells of the shift register 308 in response to a selection signal XB0 that has XB0 bits as one output 352 of the shift register 308. Similarly, the multiplexer 314 selects one of the y memory cells of the shift register 308 in response to a selection signal XB1 that has XB0 bits as another output 358 of the shift register 308. Depending on the state of multiplexers 316 and 320, the selected outputs can be routed to the crossbar 101 for consumption by the data inputs of processor units 103.

The memory 326 has an input port DI and an output port DO for storing data to permit the shift register 308 to be spilled over due to its limited size. In other words, the data in the shift register 308 may be loaded from and/or stored into the memory 326. The number of intermediate signal values that may be stored is limited by the total size of the memory 326. Since memories 326 are relative inexpensive and fast, this scheme provides a scalable, fast and inexpensive solution for logic simulation. The memory 326 is addressed by an address signal 377 made up of XB0, XB1 and Xtra Mem. Note that signals XB0 and XB1 were also used as selection signals for multiplexers 312 and 314, respectively. Thus, these bits have different meanings depending on the remainder of the instruction. These bits are shown twice in FIG. 3, once as part of the overall instruction 382 and once 380 to indicate that they are used to address the memory 326.

The input port DI is coupled to receive the output 371-372-374 of the PE 302. Note that an intermediate value calculated by the PE 302 that is transferred to the shift register 308 will drop off the end of the shift register 308 after y shifts (assuming that it is not recirculated). Thus, a viable alternative for intermediate values that will be used eventually but not before y shifts have occurred, is to transfer the value from PE 302 directly to the memory 326, bypassing the shift register 308 entirely (although the value could be simultaneously made available to the crossbar 101 via path 371-372-376-368-362). In a separate data path, values that are transferred to shift register 308 can be subsequently moved to memory 326 by outputting them from the shift register 308 to crossbar 101 (via data path 352-354-356 or 358-360-362) and then re-entering them through a PE 302 to the memory 326. Values that are dropping off the end of shift register 308 can be moved to memory 326 by a similar path 363-370-356.

The output port DO is coupled to the multiplexer 324. The multiplexer 324 selects either the output 371-372-376 of the PE 302 or the output 366 of the memory 326 as its output 368 in response to the complement (˜en0) of bit en0 of the signal EN. In this example, signal EN contains two bits: en0 and en1. The multiplexer 320 selects either the output 368 of the multiplexer 324 or the output 360 of the multiplexer 314 in response to another bit en1 of the signal EN. The multiplexer 316 selects either the output 354 of the multiplexer 312 or the final entry 363, 370 of the shift register 308 in response to another bit en1 of the signal EN. The flip-flops 318, 322 buffer the outputs 356, 362 of the multiplexers 316, 320, respectively, for output to the crossbar 101.

Referring to the instruction 382 shown in FIG. 3, the fields can be generally divided as follows. P0 and P1 determine the inputs from the crossbar to the PE 302. EN is primarily a two-bit opcode that will be discussed in further detail below. Boolean Func determines the logic gate to be implemented by the PE 302. XB0, XB1 and Xtra Mem either determine the outputs of the processor unit to the crossbar 101, or determine the memory address 377 for memory 326. Note that Xtra Mem is not a required bit, and Xtra Mem=0 is also a valid condition.

In one embodiment, four different operation modes (Evaluation, No-Operation, Store, and Load) can be triggered in the processor unit 103 according to the bits en1 and en0 of the signal EN, as shown below in Table 1:

TABLE 1
Op Codes for field EN

| Mode | en1 | en0 |
|---|---|---|
| Evaluation | 0 | 0 |
| No-Op | 0 | 1 |
| Load | 1 | 0 |
| Store | 1 | 1 |

Generally speaking, the primary function of the evaluation mode is for the PE 302 to simulate a logic gate (i.e., to receive two inputs and perform a specific logic function on the two inputs to generate an output). In the no-operation mode, the PE 302 performs no operation. The mode may be useful, for example, if other processor units are evaluation functions based on data from this shift register 308, but this PE is idling. In the load and store modes, data is being loaded from or stored to the local memory 326. The PE 302 may also be performing evaluations. U.S. patent application Ser. No. 11/238,505, “Hardware Acceleration System for Logic Simulation Using Shift Register as Local Cache,” filed Sep. 28, 2005 by Watt and Verheyen, provides further descriptions of these modes, which are incorporated herein by reference.

In FIGS. 1-3, for clarity, the operation of the simulation processor 100 was explained in the context of 2-state dyadic operations. That is, the PE 302 receives two input signals (from multiplexers 304 and 306, respectively) and produces one output signal 371, and each of the signals can take one of two possible states: 0 or 1. However, as noted above, the simulation processor 100 is not limited to this situation. In alternate embodiments, multiple input signals and multiple output signals can be used, and/or the various signals can take more than two states.

For logic simulation, 4-state operation can be desirable, with the four states being 0 (logic low), 1 (logic high), X (uninitialized or conflict) and Z (not driven). FIG. 4 shows truth tables of different variations of a 4-state dyadic AND operator. The upper left truth table is for the dyadic logic function &(000). In this nomenclature, & is the symbol for the AND operator. The “bubble code” (000) indicates whether the output, A input or B input are inverted, with 0 indicating no inversion and 1 indicating inversion. Thus, &(000) represents the Boolean function [A AND B] since no variables are inverted, &(100) represents [NOT (A AND B)] because the 1 in the first position indicates that the output is inverted, &(010) represents [(NOT A) AND B] because the 1 in the second position indicates that the input A is inverted, and so on. The term “bubble code” is used because in circuit symbols, inversion is often denoted by a bubble. The variations &(000), &(001), &(010), &(011), etc. may be referred to as bubbled variants of the underlying operator (which is AND in this example).

Denoting the input signals as A and B, for a 2-state dyadic logic function, each of A and B can take one of two possible values, so the truth table has 2×2=4 entries. Each of the 4 entries can take 2 possible states so there are 2ˆ4=16 unique truth tables. Referring to FIG. 3, the field Boolean Func encodes which of the 16 possible truth tables is implemented by the PE 302. The field is 4 bits long in order to select from the 16 possible truth tables.

In the 4-state case (FIG. 4), each of A and B can take one of four possible values, so the truth table has 4×4=16 entries. Each entry can take four possible states, yielding 4ˆ16=2ˆ32 or approximately 4 billion unique truth tables. Viewed another way, if the states are encoded as two bit codes, then two truth tables are required—one for the low bit of the output state and one for the high bit of the output state—yielding 2ˆ16*2ˆ16 or approximately 4 billion possible combinations. The field Boolean Func would have a length of 32 bits if all of these truth tables were directly supported by the instruction set. However, this would add 32−4=28 additional bits to the length of the instruction for each PE, or 28n bits for the instructions for all n PEs. Since instruction length is at a premium, it is desirable to avoid lengthening the instruction by so much.

In an alternate embodiment, the length of Boolean Func is increased from 4 bits for 2-state operation to only 5 bits for 4-state operation. This is accomplished by encoding a subset of the 4 billion possible truth tables rather than all of the 4 billion possible truth tables. The selected truth tables will be referred to as the basic truth tables (or logic functions) or the basic set of truth tables (or logic functions). Non-basic logic functions are simulated by decomposing them into basic logic functions. The basic logic functions should be selected so that all logic functions which may be encountered can be constructed. For convenience, this broader set of logic functions shall be referred to as the realizable set or the realizable logic functions. For example, if AND(000) and NOT(000) are selected as basic logic functions and NAND(000) is a realizable but non-basic logic function, NAND(000) can be constructed as AND(000) followed by NOT(000). This is a more complex implementation of NAND(000), but has the advantage of reducing the instruction length.

In one application, the basic set is selected to support the Verilog language, as follows. The PE shown in FIG. 3 can handle up to two input signals and one output signal and therefore can directly implement all the unary and dyadic operators in Verilog, as well as Verilog special functions which require only two inputs. Accordingly, this subset of 35 Verilog operators is selected as the starting point for defining the basic set: &[AND], |[OR], ˆ[XOR], buf[BUF], =[IDENTITY], ˜[NOT (inversion)], ![logical NOT (zero test)], &&[logical AND], ||[logical OR], ==(equality, Z, X compares are invalid), ===(identical, Z, X compares are valid), !=(not equal), !==(not identical), wire, tri0, tri1, wand, wor, pmos, nmos, tranif0, tranif1, bufif0, bufif1, notif0, notif1, +, −, /, %, *, logic0, logic1, logicX and logicZ. Verilog operators that are more complex, e.g. functions with more than two input signals such as MUX, can be represented by combinations of the 35 operators listed above.

Including all bubbled variants of each of these 35 operators yields a total of 280 different expressions that may be encountered. However, many of these expressions are logically equivalent (i.e., they have the same truth table). For example &(000) is logically equivalent to |(111). Thus, the 280 expressions yield a realizable set of 70 unique logic functions. This entire set could be used as the basic set, with a 7-bit long Boolean Func field for a straightforward encoding (but an inefficient one since 70 is just over 64, the 7-bits allows 128).

However, in this implementation, the instruction length is shrunk to 5 bits by further reducing the set of 70 unique logic functions to only 32 logic functions. In this example, the following 32 logic functions are selected as the basic set of logic functions: &(000), &(001), &(010), &(011), &(100), &(101), &(110), &(111), ˆ(000), ˆ(001), ˜(000), ˜(001), =(000), ===(000), ===(100), wire(000), tri0(000), tri1(000), wand(000), wor(000), pmos(000), pmos(001), pmos(010), pmos(011), pmos(100), pmos(110), bufif0(000), bufif0(010), logic0, logic1, logicZ and logicX.

The realizable set of 68 unique logic functions was reduced to the basic set of 32 logic functions using a number of different principles. For example, many of the operators are commutative. That is, the two input variables can be interchanged with each other. As a result, some of the bubbled variants can be excluded from the basic set since the same logic function can be simulated by another bubbled variant of the same operator, but with the inputs interchanged. For example, note that both AND(010) XY [i.e. (NOT X) AND Y] and AND(001) XY [i.e. X AND (NOT Y)], are included in the basic set. However, the expression AND(001) XY can be simulated as AND(010) YX, and this interchanging of inputs can be carried out by the compiler. Hence, not much is lost by excluding AND(001) from the basic set. For convenience, logic functions such as AND(010) and AND(001) shall be referred to as commutative equivalents. This technique has been explained using AND as the example operator. However, it is not applied to AND in this case because AND is a common operator. However, the technique is used with operators such as ===(reducing 8 bubbled variants of the operator to 2 basic logic functions), wire (reducing 8 to 1), tri0 (2 to 1), tri1 (2 to 1), wand (5 to 1) and wor (6 to 1), for a net savings of 24 logic functions.

Another choice was to not support the math functions % and * directly, eliminating the 12 logic functions that were introduced by them. The functions +, −and / map into other existing functions.

An additional technique is to push bubbles from the output of a gate to the inputs of the following gates. For example, pmos(100) has an inverted output. Rather than implementing pmos(100), pmos(000) could be implemented instead with the inverter pushed to the following gates. The inverter can be implemented as an extra NOT function before the next gate. Alternately, the inverter can be combined with the input of the next gate. For example, if pmos(100) were coupled to the A input of &(010), this could be simulated as pmos(000) coupled to the A input of &(000). Pushing bubbles from the outputs of gates can reduce the number of logic functions by up to a factor of two. This approach is especially useful for the pmos type of functions (pmos, nmos, tranif0, tranif1, bufif0, bufif1, notif0, notif1). This technique was used to eliminate pmos(101) and pmos(111).

These techniques together reduced the 70 logic functions by 24+12+2=38, which is sufficient to reduce the size of the basic set to 32 logic functions.

Combining all three techniques could further reduce the size of the basic set from 32 logic functions to 24: &(000), &(001), &(011), ˆ(000), ˆ(001), ˜(000), ˜(001), =(000), ===(000), wire(000), tri0(000), tri1(000), wand(000), wor(000), pmos(000), pmos(001), pmos(010), pmos(011), bufif0(000), bufif0(010), logic0, logic1, logicX and logicZ. However, because 24 logic functions still require 5 bits for the Boolean Func field, the reduction from 32 to 24 logic functions does not result in an immediate reduction in the size of the instruction set and the use of the 32 function basic set allows the compiler more flexibility. As a result, this further reduction in the size of the basic set was not adopted. However, as shown by this example, it should be clear that many other combinations for the basic set are possible.

The process for selecting which truth tables are included in the basic set can proceed in many different sequences, and different basic sets can be selected. In addition, many expressions are logically equivalent (i.e., produce the same truth table). Hence, a basic set that contains the logic functions &(000), &(001), &(010), &(011), &(100), &(101), &(110), &(111) is the same as a basic set that contains the logic function |(000), |(001), |(010), |(011), |(100), |(101), |(110), |(111). Special care should be given to 4-state specific functions, such as ‘===’ or ‘wand’, ‘wor’ and ‘pmos’, as their 4-state definition is different than their equivalent 2-state definition.

The basic set of 32 logic functions can be encoded with a 5-bit Boolean Func field. In fact, two more logic functions could be added to the basic set without requiring additional bits in the Boolean Func field, since 2ˆ5 equals 32. The remaining logic functions in the realizable set are decomposed into combinations of the basic functions, typically during the compile stage.

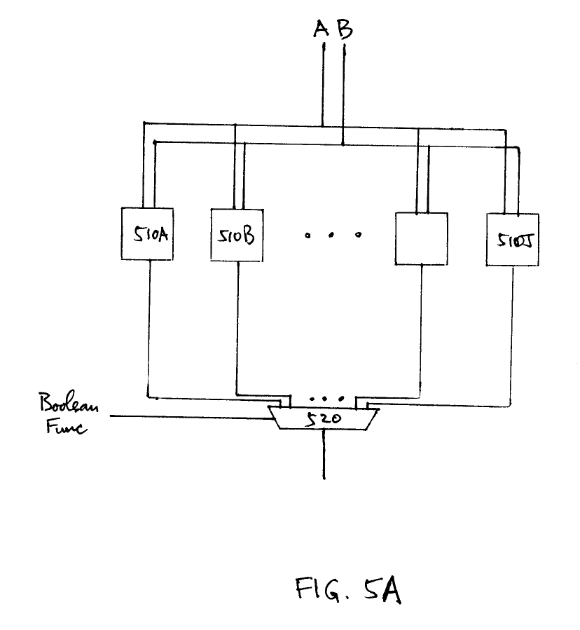

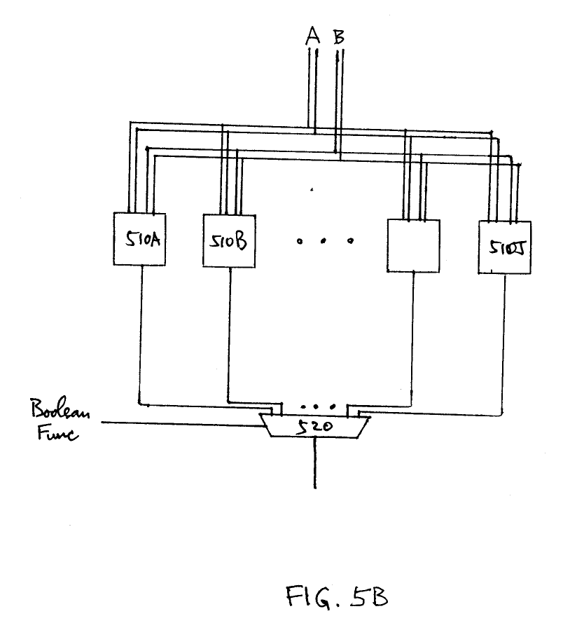

FIG. 5A is a block diagram illustrating a PE 302 according to a first embodiment of the present invention. In this example, assume that the basic set contains J logic functions (J=30 in the example above). Each of the J logic functions is computed in parallel by the circuitry 510A-510J. The multiplexer 520 selects which of the J logic functions to output, based on the field Boolean Func. This implementation is hardware intensive but fast.

In addition, although FIG. 5A shows J separate circuits, this is done for clarity of illustration. In various implementations, some circuitry may be used to generate more than one logic function. In the example above, the basic set included all eight bubbled variants of AND. Eight separate circuits typically are not required to implement all eight bubbled variants; parts of the circuitry (e.g., the basic AND functionality) may be shared. On the other hand, some implementations may use separate circuitry, one circuit for each basic logic function. For example, if the processor element is implemented on an FPGA then the basic logic functions may be implemented by dedicated lookup tables: one for &(000), another for &(001), and so on.

Each of the lines in FIG. 5A represented a single variable. Multi-state variables typically require multiple physical lines to represent the variable. For example, 4-state variables typically are encoded using two bits. The states 0, 1, X and Z could be encoded as 00, 01, 10 and 11, for example.

FIG. 5B shows a version of FIG. 5A based on FPGA based lookup tables (i.e. a 16 bit memory lookup table using 4 address bits and producing one output value) and showing physical lines. More specifically, the circuit shown in FIG. 5B is one half of a PE; a full PE would include a second circuit similar to the one shown in FIG. 5B. In FIG. 5B, the input variable A takes two lines, one for each bit A1 and A0. The same is true for input variable B. The circuit 510A can therefore be a pre-computed 4-input, 1-output lookup table. The four inputs are the bits A1, A0, B1 and B0. The one output is the high bit of the 4-state output variable. The MUX 520 selects the correct high bit from circuits 510A-510J based on the Boolean Func variable. A second circuit, similar in architecture to the one shown in FIG. 5B, generates the low bit of the 4-state output variable. The content of the circuits 510 A thru 510 J, configured as lookup tables, generally will not be identical—hence the requirement for two circuits as shown in FIG. 5B.

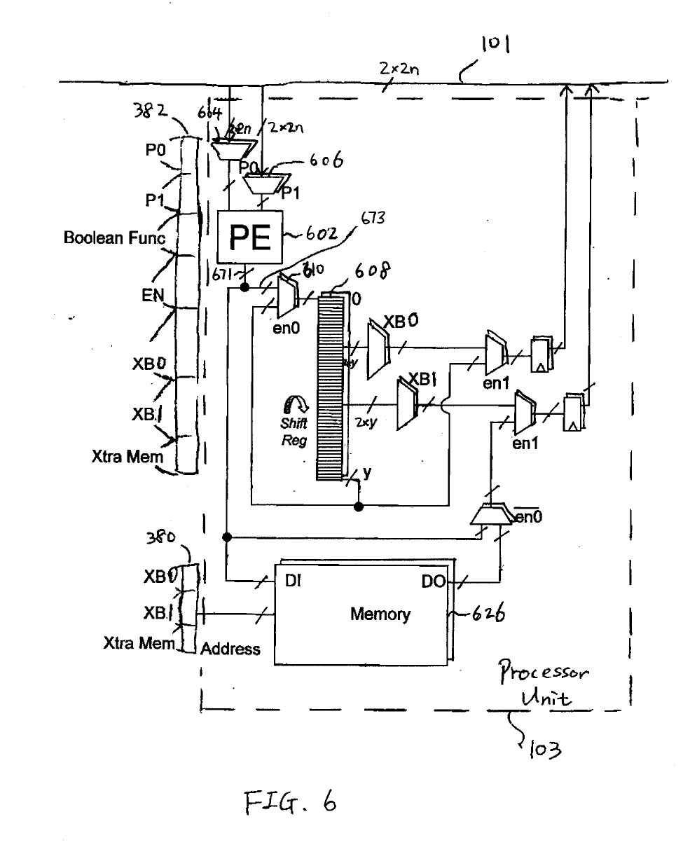

FIG. 6 expressly shows how the circuit of FIG. 3 could be implemented to support multi-state logic. If FIG. 3 was supporting two-state signals (i.e. a single bit (0, 1) per signal), then each signal line shown in FIG. 3 would be implemented as a single wire. In FIG. 6, the signals are the same, but their encoding has been moved to 4-state (0, 1, X, Z)—i.e. two bits (00, 01, 10, 11) per signal—and their implementation is realized as two wires per each signal.

FIG. 6 shows this by “shadowing” which parts of the graph have become 4-state. The instruction word has not changed, other than the change of the Boolean Func from 4 bits for 2-state to 5 bits for 4-state. All signals depicted in the graph are still the same signals, except that they represent multiple wires for each signal. Similarly, if the graph is moved to 8-state encoding, each signal requires 3 bits per signal, or 3 wires per signal, to represent 8 states (000 thru 111). The graph does not change. The size of the PE grows (in order to implement more complex logic functions).

Using the above example, for 2-state, the PE contains one instantiation of FIG. 5 to produce the 1-bit output. The instantiation of FIG. 5 takes 1-bit inputs A and B, and contains 16 circuits 510A-510J each of which is a 2-input, 1-output lookup table, and the 4-bit Boolean Func selects the correct output bit. For 4-state, the PE uses two instantiations of FIG. 5, one to produce each of the two output bits. Each instantiation of FIG. 5 takes 2-bit inputs A and B, and contains 32 (2ˆ5) pre-computed tables each of which is a (up to) 4-input, 1-output lookup table. The 5 bit Boolean Func is now a selector controlling which of the 32 tables to select. For 8-state, the PE uses three instantiations of FIG. 5, and the Boolean Func field typically will be larger to select from a larger set of tables. E.g. if the Boolean Func field equals 8 bits, each of the 3 instantiations of FIG. 5 would represent 256 (2ˆ8) tables, and so forth.

Although the present invention has been described above with respect to several embodiments, various modifications can be made within the scope of the present invention. For example, dyadic functions were used above, but the principles shown above can also be applied to multi-input functions. The basic set may include multi-input functions. Alternatively, certain types of multi-input functions can be constructed from dyadic functions, for example if the basic set includes only dyadic functions.

As another example, 2-state and 4-state examples were described above but other numbers of states can also be used. In general, an N-state dyadic function has a truth table with Nˆ2 entries, each of which can take N values. Thus, there are Nˆ(Nˆ2) possible truth tables. To directly encode all of these possibilities would require a Boolean Func field of length ceiling[log2(Nˆ(Nˆ2))] bits where ceiling(x) is the smallest integer greater than or equal to x and log2(x) is log base 2 of x. Basic sets that contain less than Nˆ(Nˆ2) logic functions or use a fewer number of bits to encode the Boolean Func field would be preferred.

In another aspect, the simulation processor 100 of the present invention can be realized in ASIC (Application-Specific Integrated Circuit) or FPGA (Field-Programmable Gate Array) or other types of integrated circuits. It also need not be implemented on a separate circuit board or plugged into the host computer 110. There may be no separate host computer 110. For example, referring to FIG. 1, CPU 114 and simulation processor 100 may be more closely integrated, or perhaps even implemented as a single integrated computing device.

Although the present invention is described in the context of logic simulation for semiconductor chips, the VLIW processor/accelerator architecture presented here can also be used for other applications that use integer logic (i.e., operations using integer variables). For example, the processor architecture can also be applied to fixed width computing (e.g., integer programming) or even to floating point computing (since floating point computations ultimately rely on integer variables, albeit very long integer variables).

In one possible implementation, the instruction set supports +, −, *, %, /, <<,>>, ˜, 2's complement, =(assignment), &, |, ˆ, >, <, and ==, for a total of 16 functions or 4 bits for the part of the instruction that specifies the function. In one implementation, the basic architecture shown in FIG. 5 is straightforwardly extended to this case. For example, if the PE implements 4-bit integer arithmetic, each operand A and B flowing into each of the functions 510A-510J is 4 bits wide, and the output of the selector 520 is also 4 bits wide (excluding carry). There would be 16 circuits 510A-510J, each implementing one of the functions supported by the instruction set. Circuit 510 A might implement +, circuit 510 B implements −, and so on. The multiplexer 520 selects the correct output based on the 4-bit field Boolean Func (although in this case a name such as Arithmetic Func would be more appropriate). The architecture based on 4-bit integer arithmetic is also known as a nibble architecture. PEs for implementing nibble architecture can also be based on approaches other than the one shown in FIG. 5.

Nibble operations can be used as a building block to build up 8-bit (byte), 16-bit or longer operations. For example, the multiply (*) operator implies an n*n bit multiplier and this can take up a large amount of silicon area. Therefore, if an 8-bit multiplier is desired, rather than adapting FIG. 5 to 8-bit wide operands A and B, FIG. 5 can be adapted to 4-bit wide operands A and B (i.e., 4-bit multiplier) and various 4-bit operations combined to produce an 8-bit multiplier. Specifically, the byte-wide operands A and B can each be broken into two nibbles. Let A=AH+AL, in which AH represent the highest 4 bits and AL represent the lowest 4 bits. If A was 8′b01011100, AH would be 8′b01010000 and AL would be 8′b00001100. Similarly, B=BH+BL. Now, A*B=AH*BH+AH*BL+AL*BH+AL*BL. The righthand side can be calculated using 4-bit input, 8-bit output operations. In this approach, the 8-bit multiplication A*B takes four 4bit-to-8bit multiplications and three 8-bit addition operations. This approach typically occupies less area than the full width operation A*B. Other extensions, such as fused multiply-add (FMADD), can also be realized. The basic approach shown above can be extended to other higher-width arithmetic, while only implementing certain functions in the lower-width arithmetic.

In this architecture, the operational frequency of the VLIW processor typically is determined by the memory access time for fetching instructions from the program memory 121, which is fairly slow compared to frequencies that are realizable inside silicon. As a result, mapping even complex functions such as the multiply function (*) inside e.g. circuit 510 A becomes feasible by allowing multiple logic steps before producing the output of circuit 510 A. This enables a structure in which some or all PEs can handle multi-bit inputs for both operands A and B and also multi-bit output signals. For example, this technique could allow PEs to accept two 64-bit inputs, use circuits 510A-510J to implement the 16 arithmetic functions listed earlier, and produce a 64-bit output. In other words, PEs could implement double precision floating point operations (FLOP). With n PEs in the grid, it is possible to compute n FLOPS in each clock cycle. Since in this approach the instructions are coming from external memory, this n FLOPS per clock cycle is a sustainable rate.

In addition, the logic resources (i.e., size of the PE) required to implement a certain width operation typically grows with the width. Therefore, in another variation, different PEs may have different capabilities and/or different widths. Some PEs may be capable of 8-bit operations while others are limited to 4-bit operations. Alternately, some PEs might handle 4-bit input, 8-bit output operations while others handle 8-bit input, 8-bit output operations. Note that even though individual PEs may vary in width, ranging from n-bit integer arithmetic to n-bit floating point functions, the length of the field Arithmetic Func can be kept the same. What is thus realized is an arbitrary bit-width VLIW processor, in which the instructions do not change. The width of the VLIW processor can be targeted to various applications, such as 8, 16, and 24 bit arithmetic, used in signal processing, 32 and 64 bit arithmetic, used in floating point arithmetic or other combinations.

The description above explained how the basic VLIW architecture, which was originally introduced in the context of logic simulation, can be extended to arithmetic functions. The architecture can be extended in a similar way to vector programming. As a result, the VLIW architecture has advantages for many applications other than just logic simulation. Applications that have inherent parallelism are good candidates for this processor architecture. In the area of scientific computing, examples include climate modeling, geophysics and seismic analysis for oil and gas exploration, nuclear simulations, computational fluid dynamics, particle physics, financial modeling and materials science, finite element modeling, and computer tomography such as MRI. In the life sciences and biotechnology, computational chemistry and biology, protein folding and simulation of biological systems, DNA sequencing, pharmacogenomics, and in silico drug discovery are some examples. Nanotechnology applications may include molecular modeling and simulation, density functional theory, atom-atom dynamics, and quantum analysis. Examples of digital content creation include animation, compositing and rendering, video processing and editing, and image processing. Accordingly, the disclosure of the present invention is intended to be illustrative, but not limiting, of the scope of the invention, which is set forth in the following claims.

What is claimed is:

1. A simulation processor for performing multi-state logic simulation of a logic design, the simulation processor comprising:
an interconnect system; and
a plurality of processor units communicatively coupled to each other via the interconnect system, wherein at least half of the processor units include a processor element for receiving multi-state inputs and configurable to implement multi-state logic.

2. The simulation processor of claim 1 wherein the processor elements are configurable to simulate a 4-state logic function.

3. The simulation processor of claim 2 wherein the 4-state logic function to be simulated is determined by an instruction received by the processor unit.

4. The simulation processor of claim 2 wherein the 4-state logic function to be simulated is determined by a field of an instruction received by the processor unit, and the field has less than seven bits.

5. The simulation processor of claim 2 wherein the 4-state logic function to be simulated is determined by a field of an instruction received by the processor unit, and the field has five bits.

6. The simulation processor of claim 2 wherein the 4-state logic function to be simulated is determined by an instruction received by the processor unit, the instruction is selected from an instruction set that can implement a basic set of 4-state logic functions, and the basic set of 4-state logic functions is smaller than a realizable set of 4-state logic functions for the logic design.

7. The simulation processor of claim 6 wherein the basic set of 4-state logic functions includes at least one bubbled variant of a NOT operator.

8. The simulation processor of claim 6 wherein the basic set of 4-state logic functions includes at least two bubbled variants of at least one operator.

9. The simulation processor of claim 6 wherein the basic set of 4-state logic functions includes at least all eight bubbled variants of at least one operator.

10. The simulation processor of claim 6 wherein the basic set of 4-state logic functions includes at least all eight bubbled variants of the AND operator.

11. The simulation processor of claim 6 wherein the basic set of 4-state logic functions includes exactly J 4-state logic functions and J is a power of two.

12. The simulation processor of claim 1 wherein the multi-state logic function to be simulated is determined by an instruction received by the processor unit.

13. The simulation processor of claim 12 wherein the instruction is selected from an instruction set that can implement a basic set of multi-state logic functions, and the basic set of multi-state logic functions is smaller than a realizable set of multi-state logic functions for the logic design.

14. The simulation processor of claim 12 wherein the simulation processor simulates non-basic multi-state logic functions by constructing them from basic logic functions.

15. The simulation processor of claim 1 wherein:
the processor elements are configurable to simulate an N-state logic function;
the N-state logic function to be simulated is determined by a field of an instruction received by the processor unit; and
the field has fewer than ceiling[log2(Nˆ(Nˆ2))] bits.

16. The simulation processor of claim 1 wherein:
the multi-state logic function to be simulated is determined by an instruction received by the processor unit, and the instruction is selected from an instruction set that can implement a basic set of J multi-state logic functions; and
each processor element comprises:
circuitry for generating output signals for all J basic multi-state logic functions; and
a multiplexer for selecting one of the output signals based on the received instruction.

17. The simulation processor of claim 16 wherein the circuitry includes J lookup tables, each lookup table generating the output signal for one of the J basic multi-state logic functions.

18. The simulation processor of claim 1 wherein the interconnect system comprises a non-blocking crossbar.

19. The simulation processor of claim 1 wherein the processor units are substantially the same.

20. The simulation processor of claim 1 wherein the plurality of processor units comprises at least 25 processor units.

21. The simulation processor of claim 1 wherein the plurality of processor units comprises at least 50 processor units.

22. The simulation processor of claim 1 wherein all of the processor units include a processor element for receiving multi-state inputs and configurable to implement multi-state logic.

23. A method for performing multi-state logic simulation of a logic design, the method comprising:
decomposing logic functions to be simulated into basic multi-state logic functions; and
implementing the basic multi-state logic functions on a processor element that receives multi-state inputs and is configurable to implement multi-state logic.

24. A VLIW processor for implementing integer logic, the VLIW processor comprising:
an interconnect system; and
a plurality of processor units communicatively coupled to each other via the interconnect system, wherein each of the processor units includes a processor element configurable to simulate any of a basic set of multi-state logic functions, wherein the integer logic can be constructed from the basic set of multi-state logic functions.

25. A computer system comprising:
a host processor; and
a hardware accelerator controlled by the host processor, the hardware accelerator comprising:
a VLIW processor having (a) an interconnect system and (b) a plurality of processor units communicatively coupled to each other via the interconnect system and configurable to implement multi-state integer functions;
a program memory accessible by the VLIW processor for storing instructions to be executed by the VLIW processor; and
a storage memory separate from the program memory and accessible by the VLIW processor for storing data used by the VLIW processor.

26. The computer system of claim 25 wherein at least one of the processor units receives multi-bit integer operands and is configurable to implement multi-bit integer arithmetic.

27. The computer system of claim 26 wherein said processor unit is configurable to implement any of the integer arithmetic functions +, −, *, and /.

28. The computer system of claim 26 wherein said processor unit is configurable to implement any of the integer arithmetic functions +, −, *, /, <<,>>, ˜, 2's complement, =(assignment), &, |, ˆ, >, <, and ==.

29. The computer system of claim 26 wherein different processor units are configurable to implement different width integer arithmetic functions.

30. The computer system of claim 26 wherein a majority of the processor units are configurable to implement multi-bit integer arithmetic functions.

31. The computer system of claim 26 wherein a majority of the processor units are configurable to implement lower-width integer arithmetic functions; and the instructions implement higher-width integer arithmetic by combinations of lower-width integer arithmetic functions.

32. The computer system of claim 25 wherein at least one of the processor units receives floating point operands and is configurable to implement floating point arithmetic.

33. The computer system of claim 25 wherein at least one of the processor units receives vector operands and is configurable to implement vector functions.
